(19) United States
(12) Patent Application Publication
(10) Pub. No.: US 2005/0120213 A1
(43) Pub. Date: Jun. 2, 2005

(54) System and method for provisioning and authenticating via a network

(75) Inventors: Nancy Cam Winget, Mountain View, CA (US); Hao Zhou, Solon, OH (US); Mark Krischer, Lane Cove (AU); Joseph A. Salowey, Seattle, WA (US); Jeremy Stieglitz, Menlo Park, CA (US); Saar Gillai, Mountain View, CA (US); Padmanabha Cheluvaraju Jakkahalli, Sunnyvale, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Cisco Technology, Inc., San Jose, CA (US)

(21) Appl. No.: 10/724,995

(22) Filed: Dec. 1, 2003

(51) Int. Cl. H04L 9/00

(52) U.S. Cl. 713/171

(57) ABSTRACT

System architecture and corresponding method for securing communication via a network (e.g. IEEE 802.11) is provided. In accordance with one embodiment, the present system and method protocol, may be suitably configured to achieve mutual authentication by using a shared secret to establish a tunnel used to protect weaker authentication methods (e.g. user names and passwords). The shared secret, referred to in this embodiment as the protected access credential may be advantageously used to mutually authenticate a server and a peer upon securing a tunnel for communication via a network. The present system and method disclosed and claimed herein, in one aspect thereof, comprises the steps of 1) providing a communication implementation between a first and a second party; 2) provisioning a secure credential between the first and the second party; and 3) establishing a secure tunnel between the first and the second party using the secure credential.

### BACKGROUND OF THE ART

The IEEE (Institute of Electrical and Electronic Engineers) 802.11 and 802.1x standards provide guidelines for allowing users to wirelessly connect to a network and access basic services provided therein. It has become more evident in recent years that security and controlled access are necessities in light of the large amount of sensitive information that is communicated over networks today.

With the advent of wireless telecommunications, there is an increasing need for the establishment of security to provide data confidentiality and data authenticity. When two or more wireless parties (e.g. a server and a mobile client) wish to establish a level of security, they will typically “authenticate.” In other words, the two parties prove to each other that they really are who they say they are. The proof of identity is typically through some form of “credential.” Today, credentials are typically used to achieve authentication through one of two types of cryptographic disciplines: “symmetric cryptography” or “asymmetric cryptography.”

Symmetric cryptography is based on the use of a “pre-shared secret,” whereby both parties obtain the secret through some protected external means. For example, they may rely on a central source for the distribution of a “pre-shared secret.” As well, one of the parties may disclose the “pre-shared secret” through some other protected means prior to its use. For example, the pre-shared secret might be a typical “user ID/password” assigned to a user by a network administrator. Nonetheless, the pre-shared secret must be obtained in a protected means to avoid any other party from learning the value or content of the pre-shared secret.

On the other hand, asymmetric cryptography is based on newer technologies, such as “Public Key Infrastructure” (PKI) which can enable a “zero knowledge” approach as proof of identification. However, while providing a higher level of security than possible with symmetric approaches, the PKI approach, while it may not require a shared secret between the two parties, must rely on a third party (known as a Certificate Authority) or must rely on some apriori knowledge to validate the authenticity of the public key. Hence, PKI techniques are far more costly, and may be prohibitively expensive to implement on some wireless networks. Additionally, the PKI approaches often require a third party to authenticate the PKI credentials.

Existing authentication protocols, such as EAP-TLS, EAP-TTLS, or PEAP act as authentication protocols designed to achieve mutual authentication directly or through the use of a protected tunnel to enable the use of weaker credentials by the client. To provide strong security, these protocols are typically deployed with the use of asymmetric cryptography which typically requires PKI.

In the case of EAP-TTLS and PEAP, the PKI is used to establish protected communications. This PKI requirement enforces both a compute intensive enforcement of asymmetric cryptography as well as the pre-provisioning of a means by which the client can validate a server certificate (e.g. for wireless clients, this is typically achieved by provisioning the client with the server's CA certificate).

Earlier implementations deploy a lightweight user authentication protocols, (e.g. such as EAP-MCHAP or LEAP) that employs the MSCHAPv1 exchange to protect the user password as it is transmitted between a peer and authentication server. However, limitations of the MSCHAPv1 protection as well as the ease in which wireless medium can be eavesdropped leaves earlier implementations vulnerable to passive offline dictionary attacks.

Today, emergent protocols such as EAP-TTLS and PEAP have evolved to protect authentication protocols, such as LEAP, that employ weak user credentials. Further, these protocols may be partitioned into three stages:

First, the establishment of a master secret and keying material; This conversation is the first step by which, typically, a server proves its authenticity to a peer. The peer in turn, provisions the server with a master secret.

Second, the establishment of a secure tunnel; This conversation is the step by which the common master secret is used with random challenges exchanged between peer and authentication server (AS) to generate fresh keying material used to establish a secure tunnel. The tunnel is used to protect the ensuing conversation by providing message confidentiality and integrity.

Third, the protected authentication conversation; This conversation, protected by the tunnel, enables the peer to use its weak credential to prove it is authenticity to the AS.

To construct the tunnel, earlier implementation protocols may also impose the use of another (stronger) set of credentials to assure the security of the tunnel. Typically, these credentials use public key infrastructures (PKI) to convey both identity and secret material to establish the authenticity of a user (e.g. peer) or authentication server (AS). The secret material, in general, employs asymmetric cryptography to validate the presented credential as being authentic and/or to generate keying material used to protect the tunnel. Further, to provide peer identity protection, these earlier protocols only require server side authentication for the tunnel establishment and employ peer-only establishment of the master secret from which the tunnel protection is derived.

While the aforementioned protocols are evolving to better address known vulnerabilities of earlier implementations, they too inherently posses a number of burdens. For example, the computational burdens (e.g. master key establishment) imposed by the asymmetric cryptographic operations at every instance a peer desires to gain network access is a limiting factor for very small devices.

Additionally, in typical deployments today, a certificate implies the verification of the certificate signature through a certificate authority. For wireless media, it is prohibitive for peers to contact a certificate authority as the peer has not yet gained network access. Thus, in typical deployments today, peers must be provisioned with the certificate authority's certificate. In turn, the certificate authority's certificate is then used by the peer to validate the server's certificate. Beyond the implementation overhead for the certificate management, this use also imposes another asymmetric cryptographic operation at every authentication that further consumes precious resources on small devices.

Still further, in early deployments of EAP-TTLS and PEAP, the lack of cryptographic binding between the tunnel establishment and the conversation inside the tunnel allows a man-in-the-middle (MiM) attack. The MiM attack enables an adversary to successfully act as the AS to the peer and vice versa, thus enabling the adversary to control the information flow between the peer and authenticator.

Finally, to enable identity protection, earlier protocols such as EAP-TTLS and PEAP allow only server-authenticated tunnels which can be used by adversaries to hijack sessions from peers who use EAP methods that cannot be cryptographically bound to the tunnel.

What is needed is a protocol that provides more secure provisioning and authentication protocols between entities via a network. The need to provide user friendly and easily deployable network access solutions has heightened the need to enable strong mutual authentication protocols that inherently use weak user credentials. Further, what is needed is a protocol that decouples the means by which a pre-shared key is established and used to secure communications from the actual process of employing authentication mechanisms to gain access to a network.

### SUMMARY OF THE DISCLOSED EMBODIMENTS

In accordance with one embodiment, the present system and method protocol, may be suitably configured to achieve mutual authentication by using a shared secret to establish a tunnel used to protect weaker authentication methods (e.g. user names and passwords). The shared secret, referred to in this embodiment as the protected access credential may be advantageously used to mutually authenticate a server and a peer upon securing a tunnel for communication via a network. Thus, an authorization policy may be established and subsequently updated in accordance with the present system and method.

The present system and method disclosed and claimed herein, in one aspect thereof, comprises the steps of 1) providing a communication implementation between a first and a second party; 2) provisioning a secure credential between the first and the second party; and 3) establishing a secure tunnel between the first and the second party using the secure credential.

Additionally, the present system and method may comprise the step of authenticating between the first and the second party within the secured tunnel. In yet another embodiment, authenticated communication may be performed using Microsoft MS-CHAP v2.

It will be appreciated that the communication implementation may be a wired or wireless implementation. Further, the secure credential used for establishing an authenticated tunnel may be a protected access credential (PAC). It will be appreciated that the PAC may include a protected access credential or entropy key of any desired length (e.g. 32-octets). Additionally, the PAC may include a protected access credential opaque element or a protected access credential information element.

In accordance with the present system and method, the provisioning may occur through out-of-band as well as in-band mechanisms.

In another embodiment, a tunnel key may be established during the tunnel establishment phase. The establishment of the tunnel key may include the step of establishing a session_key_seed to be used in authenticated communication.

In an alternate embodiment, an asymmetric encryption algorithm may be used to derive the tunnel key subsequently used in the step of establishing a secure tunnel when provisioning a PAC. Further, an asymmetric encryption algorithm such as Diffie-Hellman key exchange may be used to derive the shared secret used to protect the authentication mechanism prior to the in-band distribution of a PAC.

### BRIEF DESCRIPTION OF THE DRAWINGS

It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

For a more complete understanding of the present system and the advantages thereof, reference is now made to the following description taken in conjunction with the accompanying drawings in which:

FIG. 1 illustrates a network block diagram that illustrates the multiple phases of communication between network components, in accordance with a disclosed embodiment;

FIG. 2 illustrates a network architectural diagram that illustrates representative network components in accordance with a disclosed embodiment;

FIG. 3 illustrates a protocol (e.g. EAP-Fast) layering model in accordance with a disclosed embodiment of the present system;

FIG. 4 illustrates a communication exchange in accordance with the authentication tunnel establishment phase of a disclosed embodiment of the present system;

FIG. 5 illustrates a communication exchange in accordance with the authentication protected authentication phase of a disclosed embodiment of the present system; and

FIG. 6 illustrates a flow chart of the information exchange between the various entities for provisioning a client, establishing a tunnel, and authenticating a trusted relationship in accordance with a disclosed embodiment.

### DETAILED DESCRIPTION OF THE DISCLOSED EMBODIMENTS

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Authenticator”, as used herein, refers to the end of the link initiating EAP authentication.

“Backend authentication server”, as used herein, refers to an entity that provides an authentication service to a peer. When used, this server typically executes EAP methods to be executed between the server and peer; the authenticator acts as a pass through filter until such time the server authenticates and authorizes the peer. At the time of successful authentication, the authorization policy is distributed from the server to the authenticator.

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Common forms of computer-readable media include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, an EPROM, a FLASH-EPROM, any other memory chip or cartridge, a carrier wave/pulse, or any other medium from which a computer, a processor or other electronic device can read. Signals used to propagate instructions or other software over a network, such as the Internet, are also considered a “computer-readable medium.”

“Diffie-Hellman”, as used herein, refers to a well known asymmetric cryptographic technique whereby a secure cipher key is generated by wireless parties from transformations of exchanged transformed signals. This cryptographic technique, also known as the “Diffie-Hellman Key Agreement” is disclosed in U.S. Pat. No. 4,200,770, the disclosure of which is hereby incorporated by reference.

“EAP server”, as used herein, refers to the entity that terminates the EAP authentication method with the peer. In the case where no backend authentication server is used, the EAP server may be part of the authenticator. In the case where the authenticator operates in pass-through mode, the EAP server may be located on the backend authentication server.

“Internet”, as used herein, includes a wide area data communications network, typically accessible by any user having appropriate software.

“Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like. Logic may also be fully embodied as software.

“Man in the Middle (MiM)”, as used herein, refers to an adversary that can successfully inject itself between a peer and authentication server. The MiM succeeds by impersonating itself as a valid peer, authenticator or authentication server.

“PAC-Opaque”, as used herein, refers to a piece of information that can be used by a server to recreate and validate the PAC-Key it issued to a client. The information is obscured from the client or any adversary such that the client or adversary can not discern the information held in the PAC-Opaque.

“Octet”, as used herein, refers to a sequence of eight bits. An octet is thus an eight-bit byte. Since a byte is not eight bits in all computer systems, octet provides a non-ambiguous term.

“Peer”, as used herein, refers to the end of the link that responds to the authenticator. In the IEEE 802.1X specification, this end is also known as the supplicant or client. Accordingly, this IEEE 802.1X definition is incorporated herein.

“Protected Access Credential (PAC)”, as used herein, refers to credentials distributed to users for future optimized network authentication, which consists of a secret part and an opaque part. The secret part is secret key material that may be used in future transactions. The opaque part is presented when the client wishes to obtain access to network resources. The PAC aids the server in validating that the client possesses the secret part.

“Protocol”, as used herein, refers to a set of rules that govern all communications between nodes and devices. Protocol may control format, timing, error correction, and running order.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

“Successful authentication”, as used herein, refers to an exchange of EAP messages as a result of which the authenticator decides to allow access by the peer, and the peer decides to use this access. The authenticator's decision typically involves both authentication and authorization aspects; the peer may successfully authenticate to the authenticator but access may be denied by the authenticator due to policy reasons.

Following are Acronyms used throughout the present disclosure:
A-ID—Authority Identifier
AS—Authentication Server
EAP—Extensible Authentication Protocol
EAP-FAST—Flexible (EAP) Authentication via Secure Tunnel Protocol
LEAP—Cisco Lightweight EAP
MAC—Message Authentication Code
MiM—Man in the middle attack
NAS—Network Access Server (typically an access point)
PAC—Protected Access Credential
PEAP—Protected EAP
PKI—Public Key Infrastructure
PRF—Pseudo Random Function
SKS—Session Key Seed
TLV—Type-Length-Value

The following includes examples of various embodiments and/or forms of components that fall within the scope of the present system that may be used for implementation. Of course, the examples are not intended to be limiting and other embodiments may be implemented without departing from the spirit and scope of the invention.

The IEEE (Institute of Electrical and Electronic Engineers 802.11 standard provides guidelines for allowing users to wirelessly connect to a network and access basic services provided therein. The content of the IEEE 802.11 and 802.1X specification standards are hereby incorporated into this specification by reference in its entirety.

In addition to definitions provided herein, the terms in this specification should be interpreted as defined, or as customarily used, in the Institute of Electrical and Electronics Engineers (IEEE) 802.11 and 802.1x specifications. The IEEE 802.11 and IEEE 802.1x specifications are hereby incorporated by reference in their entirety.

Although the embodiments of present system and method described herein are directed toward an IEEE 802.11 wireless network, it will be appreciated by one skilled in the art that the present concepts and innovations described herein may be applied to alternate wired and wireless network protocols without departing from the spirit and scope of the present innovation.

Briefly describing one embodiment of the present system and method, it provides for a protocol suitably designed to use symmetric-cryptography to allay PKI requirements present when a peer desires to gain access to the network. In other words, the present system and method alleviate the PKI requirements by decoupling the establishment of a master secret from the subsequent conversations used facilitate network access to a peer.

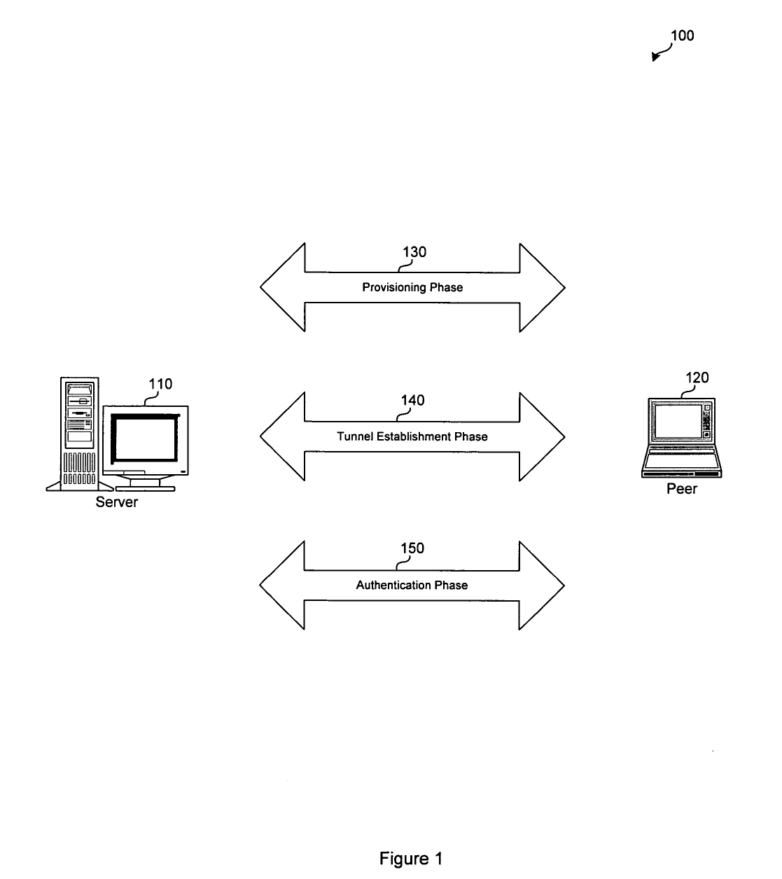

Referring to FIG. 1 and briefly describing one embodiment of the present system 100, it provides for a protocol suitably configured to protect the transmission of information in a network (e.g. wired or wireless) thereby potentially preventing session attacks and/or disruption. Specifically, one embodiment of the present innovation is directed toward a system and method configured to decouple the means by which a key may be established (e.g. master secret) between a server 110 and a peer 120 to secure communications from the actual process of employing the authentication mechanism to gain access to the network.

Generally, as illustrated in FIG. 1 and in accordance with an embodiment, the decoupling of the protocol of system 100 may be partitioned into three phases: (i) the “Provisioning Phase” 130 which may be used to establish a protected access credential (e.g. PAC); (ii) the “Tunnel Establishment Phase” 140 which may be used to achieve an authenticated key agreement for securing communications; and (iii) the “Authentication Phase” 150 whereby a secure tunnel may be suitably employed to gain network access.

As disclosed herein, an embodiment of the present system and method discloses a provisioning and authenticating method that allows for the use of an encryption technique while minimizing the risk of a Man-in-the-Middle (MiM) attack. In one embodiment, the provisioning technique may be a Diffie-Hellman key exchange technique used to mutually derive a shared secret to protect the tunnel that is used to authenticate and ultimately provision a PAC. Of course, an artisan would appreciate that any scheme other than the Diffie-Hellman approach may be used without departing from the spirit and scope of the present system and method. Similarly, with a PAC provisioned, a PAC-Key is then used to establish a mutually authenticated secure tunnel using symmetric encryption that is used to protect the weaker authentication credential to effect a peer's authentication and thus gain network access.

Overview

In accordance with one embodiment, the present system and method protocol, (also hereinafter referred to as “EAP-FAST”) is suitably configured to achieve mutual authentication by using a shared secret to establish a tunnel used to protect weaker authentication methods (e.g. user names and passwords). The shared secret, referred to in this embodiment as the Protected Access Credential key (hereinafter the PAC-Key) may be advantageously used to mutually authenticate the server 110 and the peer 120 when securing a tunnel.

The present protocol may be an extensible framework that enables mutual authentication that addresses the criteria of earlier implementations. For example, the present system 100 is suitable configured to partition the conversation into three phases as illustrated in FIG. 1.

In the Provisioning Phase 130, the peer 120 may be provisioned with a unique, strong secret referred to as the PAC which may be shared between the peer 120 and the server 110. In the embodiment, the conversation used for the provisioning phase 130 may be protected by a Diffie-Hellman key agreement to establish a protected tunnel. Of course, it will be appreciated that protocols other than Diffie-Hellman may be used in implementations of the present system without departing from the scope of the present innovation.

Further, the peer 120 may successfully authenticate itself before the server 110 provisions the peer 120 with the PAC. It will be appreciated that the Provisioning Phase 130 may be initiated solely by the peer 120 in order to alleviate the computational overhead and cost in having to establish a master secret every instance a peer 120 desires to gain access to the network. Additionally, as this in-band provisioning mechanism requires asymmetric cryptography; it will be appreciated that there may be devices for which the computational cost of the Diffie-Hellman key agreement is prohibitive. Thus, by decoupling this phase as a provisioning only conversation which is separate to the network access conversation, such devices may opt to bypass in-band provisioning by enabling out-of-band mechanisms to provision the PAC.

In other words, by decoupling this Provisioning Phase 130 as a provisioning only conversation, the present system and method provides the flexibility and extensibility in allowing both server 110 and peer 120 to utilize other tools or protocols more appropriate for their deployment scenario. For instance, while this present protocol explicitly defines one particular in-band mechanism to achieve a shared secret, it will be appreciated that other means, in-band or out-band may be employed for achieving similar results.

Continuing with the embodiment, in the Tunnel Establishment phase 130, the peer 120 and server 110 authenticate each other by use of the PAC established in the Provisioning Phase 130 whereby a fresh tunnel key is established. The tunnel key generated in the Tunnel Establishment Phase 130 is then used to protect the remaining portions of the conversation, suitably providing both message confidentiality and authenticity.

Next, in accordance with the Authentication Phase 150, within the tunnel session, a complete authentication or authorization policy may be established and executed along with proper termination and generation of the Session Keys (SKs). The Session Keys may be distributed to the network access server (e.g. access point).

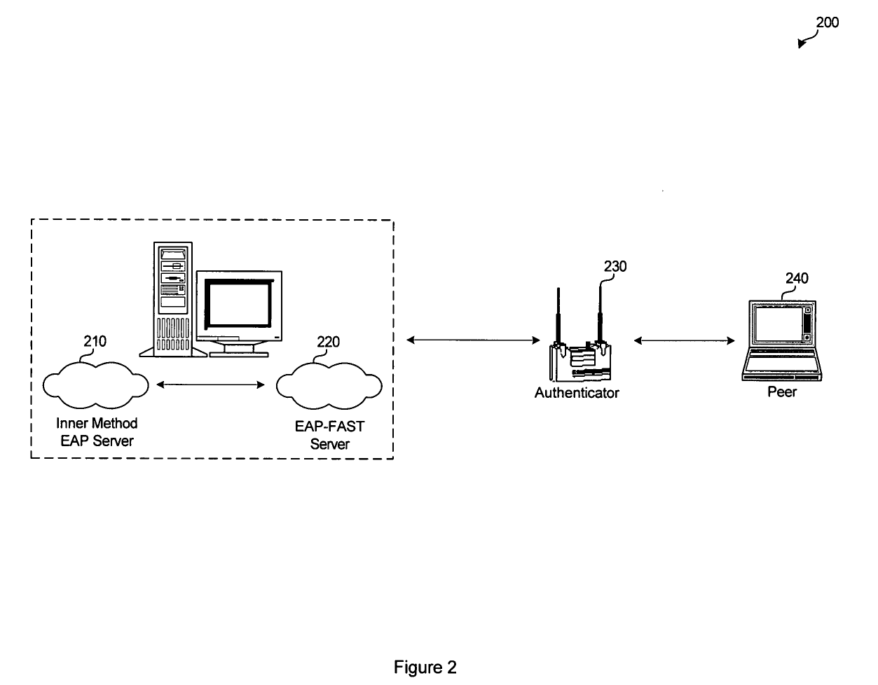

Illustrated in FIG. 2 is a simplified system component diagram of one embodiment of an architectural model of an embodiment of system 200. The system components shown in FIG. 2 generally represent the system 200 and may have any desired configuration included within any system architecture.

Referring now to FIG. 2, an embodiment of the present system 200 is shown. In accordance with the embodiment, the present system generally includes a logical Inner EAP Method Server 210, an EAP-FAST Server 220, an Authenticator 230 and a Peer 240.

In accordance with the wireless network of the embodiment, it will be appreciated that the peer 240 may be any component capable of obtaining access to a wireless network such as a laptop/notebook portable computer having Cardbus network adapter suitable for wireless communication with a wired network, an electronic tablet having a suitable wireless network adapter, a handheld device containing a suitable wireless network adapter for communicating to a wired network or the like. As well, it will be appreciated that the authenticator 230 may be a server, switch, access point or the like.

It will be appreciated that entities illustrated in FIG. 2 are logical entities and may or may not correspond to separate network components. For example, the Inner Method EAP server 210 and the EAP-FAST server 220 may suitably be configured into a single entity as illustrated in FIG. 2. As well, for example, the EAP-FAST server 220 and the authentication server 230 may be suitably configured into a single entity (not shown). Further, it will be appreciated that the functions of the Inner Method EAP server 210, the EAP-FAST server 220 and/or the authenticator 230 may suitably be combined into a single component (not shown). An artisan will appreciate that FIG. 2 illustrates the division of labor among entities in a general manner and illustrates one embodiment of a distributed system construction.

Protocol Layering Model

In accordance with EAP-FAST, packets may be encapsulated within existing known protocols. For illustration purposes, this discussion will be directed toward the use of EAP in connection with the present protocol. Of course, it will be appreciated that other protocols known in the art may be used in accordance with the present system and method without departing from the spirit and scope described herein.

Continuing with the embodiment, the packets may be encapsulated within EAP whereby EAP in turn utilizes a carrier protocol to transport the packets. Of course, the packets themselves may be suitably configured to encapsulate TLS, which may then be used to encapsulate user authentication information.

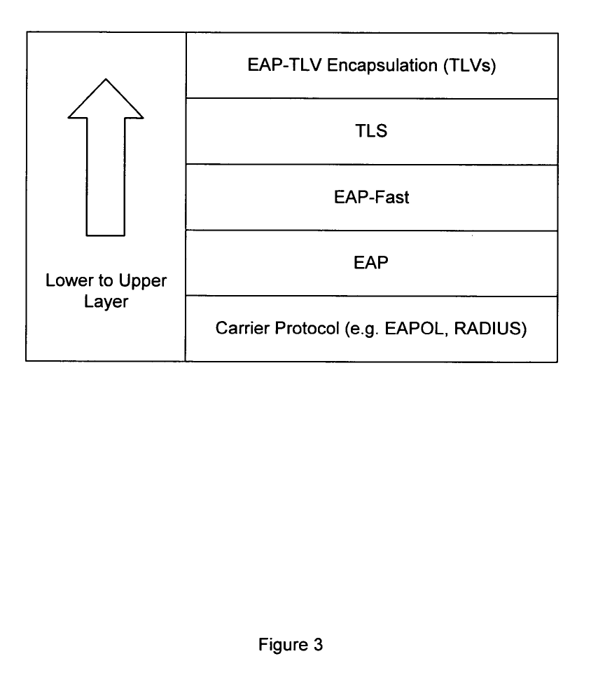

Thus, in accordance with an embodiment, the messaging can be described using a layered model, whereby each layer may be suitably configured to encapsulate the layer beneath it. Reference to FIG. 3 illustrates the relationship between protocols in accordance with the embodiment.

An artisan will appreciate that the EAP-TLV method illustrated in FIG. 3 may be a payload with standard Type-Length-Value (TLV) objects. In accordance with the embodiment, the TLV objects may be used to carry arbitrary parameters between an peer 120 and an server 110 of FIG. 1.

Continuing with the embodiment, all conversations in the Authentication Phase 150 of FIG. 1 may be encapsulated utilizing an EAP-TLV method as illustrated in FIG. 3. It will be appreciated that the EAP header portion of the EAP-TLV payload may be omitted for optimization, leaving only a list of TLVs as the payload.

An artisan will appreciate that methods for encapsulating EAP within carrier protocols is known in the art. For example, EAPOL may be used to transport EAP between a client and an access point. Likewise, RADIUS or Diameter may be used to transport EAP between an authenticator and the protocol server.

Following is a discussion of the three phases decoupled in accordance with the present system and method protocol (e.g. EAP-FAST).

Provisioning Phase 130

In operation and in accordance with one embodiment, as previously discussed, a shared secret may be established in-band by employing the Provisioning Phase 130 of FIG. 1. This shared secret which may be mutually and uniquely shared between the peer 120 and authentication server 110 may be used to secure a tunnel in accordance with the present system and method.

In one embodiment of the present system, the protocol may be advantageously configured to use the shared secret or PAC to facilitate the use of a single shared secret by a peer 120 and to minimize the per user state management on the authentication server 110.

Continuing with the embodiment, the PAC may be a security credential provided by the authentication server 110 segmented into a PAC-Key, PAC-Opaque and PAC-Info elements. It will be understood that the PAC elements may have any desired length. For example, the PAC-Key element may be a 32-Octet key used by the peer 120 to establish the tunnel in accordance with the Tunnel Establishment Phase 140.

As well the PAC-Opaque element may be a variable length field that may be sent to the authentication server 120 during the Tunnel Establishment Phase 140. It will be appreciated that the PAC-Opaque element is an obscure element that may be interpreted solely by the authentication server 120 in order to recover the PAC-Key element as well as determine the PAC's authenticity and expiry time.

In the embodiment, the third element, the PAC-Info element, may be a variable length field used to provide at minimum, the authority identity or PAC issuer. It will be appreciated that other information (e.g. PAC-Key lifetime) may be conveyed by the authentication server 120 to the peer 110 during the PAC Provisioning (or refreshment) Phase 130.

It will be appreciated that the PAC may be provisioned through out-of-band or in-band mechanisms using any desired authentication protocol (e.g. Diffie-Hellman) or through some other external application level tools. As previously discussed, all three components comprising the PAC may be provided (e.g. PAC-Key, PAC-Opaque and PAC-Info) in the Provisioning Phase 130.

Next, is a discussion of the secured Tunnel Establishment Phase 140 in accordance with an embodiment of EAP-FAST.

Tunnel Establishment Phase 140

In accordance with the embodiment, this Tunnel Establishment Phase 140 is similar to establishing a new TLS session utilizing a modified EAP type and extension to TLS handshake protocol in accordance with EAP-FAST.

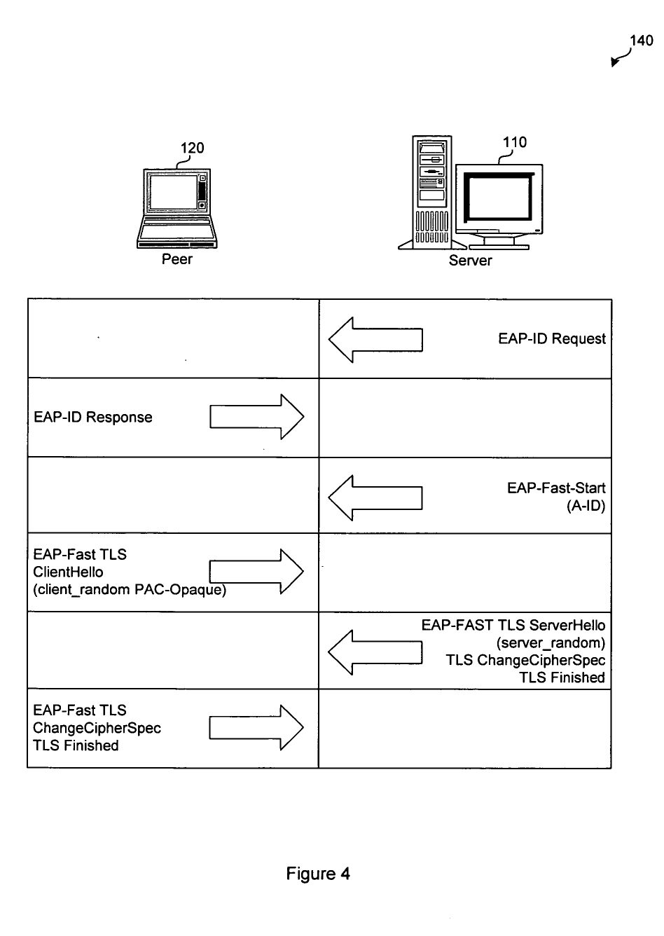

Reference to FIG. 4 illustrates an embodiment of a conversation between an authentication server 110 and a peer 120 in accordance with the Tunnel Establishment Phase 140 of the present system and method.

As illustrated in FIG. 4 and in accordance with the embodiment, the initial conversation of the Tunnel Establishment Phase 140 begins with the authentication server 110 and the peer 120 negotiating EAP.

Initially, the server 110 will typically send an EAP-Request/Identity packet to the peer 120, and the peer 120 will respond with an EAP-Response/Identity packet (e.g. username) to the server 110. It will be appreciated that the peer 120 may use an anonymous username if it desires to protect its identity.

While the EAP conversation normally occurs between the server 110 and the peer 120, it will be appreciated that the authentication server 110 may act as a pass-through device whereby the EAP packets received from the peer 120 being encapsulated for transmission to a backend authentication server (not shown). For illustration purposes, the discussion that follows, will use the term “EAP server” (e.g. 110) to denote the ultimate endpoint conversing with the peer 120.

Once the identity of the peer 120 is received and a determination is made that authentication is to occur in accordance with the present innovation protocol (e.g. EAP-FAST), the EAP server 110 responds with a Present Protocol/Start packet.

In accordance with the embodiment, the Start packet may be an EAP-Request packet with EAP-Type=EAP-FAST and the Start (S) bit set. Of course, the Start packet may also include an authority identity (A-ID) TLV to inform the peer 120 the identity of the server 110. At this point, the conversation may commence by the peer 120 sending a response in accordance with EAP-FAST.

As illustrated in FIG. 4, the data field of the EAP-Response packet may contain an EAP-FAST encapsulated TLS client_hello handshake message. Of course the client_hello message may contain the peer 120 challenge (also called the client_random) and PAC-Opaque in the TLS ClientHello extension.

It will be appreciated that as there may be multiple servers (not shown) that a peer 120 may encounter, a peer 120 may be provisioned with a server unique PAC in accordance with the present protocol. Of course, a peer 120 may be configured to cache the different PACs and to make a determination based on the received A-ID which corresponding PAC to employ.

Next, the server 110 will then respond with an EAP-Request packet with EAP-Type=EAP-FAST. As illustrated in FIG. 4, the data field of this packet may be configured to encapsulate three TLS records, ServerHello, ChangeCipherSpec and Finished messages. It will be appreciated that the ServerHello record may contain a server_random and ChangeCipherSpec. As well, the TLS Finished message sent after the ChangeCipherSpec message may contain the first protected message with presently-negotiated algorithm, keys, and secrets.

Of course, the server may be configured to generate the Tunnel key prior to composing the EAP-FAST TLS Server Hello message. As well, the peer 120 in turn, may consume the server_random in order to generate the Tunnel Key.

In accordance with the embodiment the Tunnel Key may be derived in a manner similar to TLS key calculation used in earlier implementations. However, an additional element may be generated in accordance with the present system. For example, an additional 40 octets (called session_key_seed) may be generated. The additional session_key_seed may be used in the Session key calculation in the conversation of the Authentication Phase 150 discussed below.

A specific PRF function in accordance with the embodiment of the present protocol may be used to generate a fresh master_secret from the specified client_random, server_random and PAC-Key. Of course, the PRF function used to generate keying material may be defined by TLS.

Since a PAC may be used as a credential for other applications beyond the present system and method, it will be appreciated that the PAC may be suitably configured to be further hashed using any desired random number generator (e.g. TLS-PRF) to generate a fresh TLS master_secret. As well, it will be appreciated that the session_key_seed may be used by the Authentication Phase 150 conversation to both cryptographically bind the inner method(s) to the tunnel as well as generate the resulting session keys in accordance with the present protocol.

Continuing with the embodiment and after verifying the Finished message from the server 110, the peer 120 may respond with two TLS records, a ChangeCipherSpec and the Finished message. Upon verifying the Finished message received by the peer 120, the server 110 completes the Tunnel Establishment Phase 140 by establishing the tunnel and is ready for the conversation in accordance with the Authentication Phase 150.

Following is a discussion of the Authentication Phase 150 in accordance with an embodiment of EAP-Fast.

Authentication Phase 150

Continuing with the embodiment, a second portion of the protocol conversation may include a complete EAP conversation occurring within the TLS session negotiated in the Provisioning Phase 130 and ending with a protected termination. Of course, all EAP messages may be encapsulated in an EAP Message TLV.

In accordance with the present system, the Authentication Phase 150 will occur only if establishment of a TLS session in the Tunnel Establishment Phase 140 is successful or a TLS session is successfully resumed in the Tunnel Establishment Phase 140.

As well, the Authentication Phase 150 will not occur if the peer 120 or server 110 fails authentication or if an EAP-Failure has been sent by the server 110 to the peer 120, terminating the conversation. Of course, since all packets sent within the Authentication Phase 150 conversation occur after TLS session establishment in the Tunnel Establishment Phase 140, the conversations may be protected using a negotiated TLS ciphersuite.

In operation, the Authentication Phase 150 conversation may consist of a protected EAP authentication using the user credentials (e.g. username and password). It will be appreciated that the entire EAP conversation including the user identity and EAP type may be protected from snooping and modification by the tunnel encapsulation in accordance with industry known techniques. It will further be appreciated that any method of authenticating known in the art may be used without departing from the spirit and scope of the present system and method. For example, the present innovation may utilize known mechanisms such as MS-CHAP and EAP-GTC or the like in accordance with the present system and method.

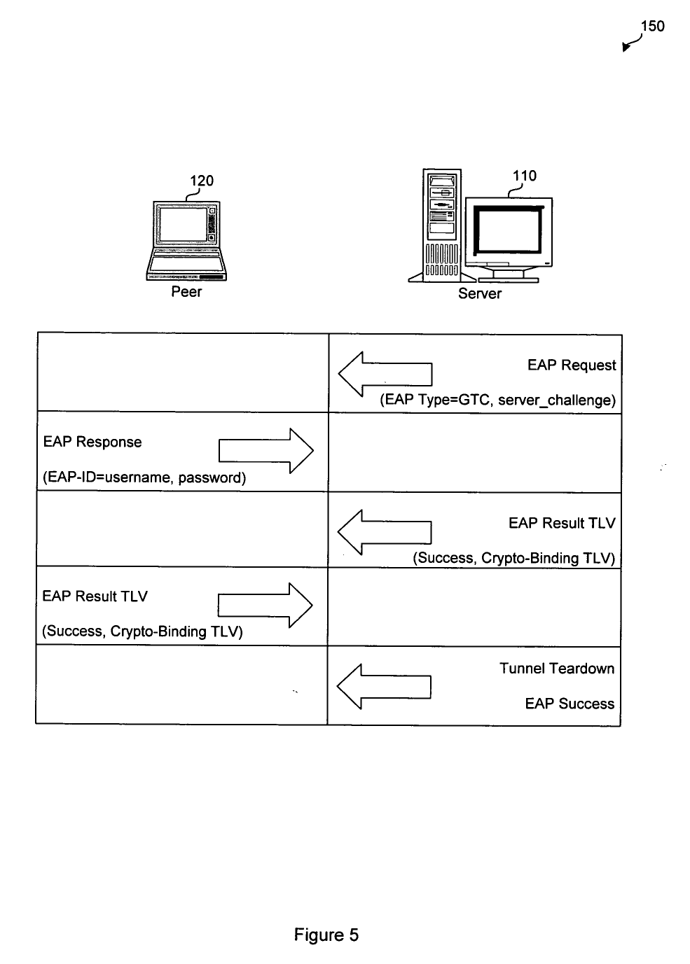

Now with reference to FIG. 5, the Authentication Phase 150 conversation begins with the server 110 sending an EAP-Request/identity packet to the peer 120, protected by the TLS ciphersuite negotiated in EAP-Fast Tunnel Establishment Phase 140. In turn, the peer 120 is suitably configured to respond with an EAP-Response/Identity packet to the EAP server 110, containing the userId of the peer 120.

After the TLS session-protected Identity exchange, the server 110 may then select authentication method(s) for the peer 120, and may send an EAP-Request with the EAP-Type set to the initial method.

It will be appreciated that the EAP conversation within the TLS protected session may involve zero or more EAP authentication methods, encapsulated by the EAP-TLV method. As well, it will be appreciated that the EAP conversation of the Authentication Phase 150 of FIG. 5 may complete protected termination.

In accordance with the protected termination, the Authentication Phase 150 conversation may be completed by exchanging both the success/failure indication (Result TLV) and the Crypto-Binding TLV within the TLS session. It will be appreciated that the Crypto-Binding TLV is present in the preceding or same packet containing a protected success indication (Result-TLV) in order to effectuate proper termination.

Of course, it will be appreciated that if the server 110 determines that a new PAC must be provisioned, the server 110 may optionally distribute a new PAC to the peer 120 at the same time with a successful protected Result TLV exchange.

### SUMMARY OF CONVERSATION PHASES

In summary and again with reference to FIG. 1, an embodiment of the present system and method commences upon the Provisioning Phase 130. Throughout the Provisioning Phase 130, the network server 110 and peer 120 may be configured to suitably establish a master or shared secret (e.g. PAC). It will be appreciated that in accordance with the present system and method, the Provisioning Phase 130 may not have to be repeated for subsequent authenticated conversations. In other words, the master secret (e.g. PAC) established in accordance with the Provisioning Phase 130 may be employed to secure multiple subsequent authenticated conversations between a server 110 and a peer 120. Note that the Provisioning Phase 130 is a separate and distinct conversation that occurs infrequently and prior to the use of the subsequent Tunnel Establishment 140 and Authentication Phase 150.

Once the shared secret is established in the Provisioning Phase 130, the present system and method may proceed to invoke the Tunnel Establishment Phase 140. In accordance with the Tunnel Establishment Phase 140, a secure channel or tunnel is established and protected by the shared secret established in the Provisioning Phase 130.

Next, the network server 110 and the peer 120 then proceed to the Authentication Phase 150. In the Authentication Phase 150, the network server 110 and peer 120 authenticate security credentials in order to finalize the secured exchange of information. As a result, the network server 110 and the peer 120 thereby ensure that they have been talking with each other and not an attacker (e.g. man-in-the-middle) by enforcing the cryptographic binding and protected Result TLV.

As previously discussed, an artisan will appreciate that the individual Provisioning Phase 130 discussed herein in accordance with present system and method (e.g. EAP-FAST) may be employed separately as well as in different chronological order as discussed in the embodiments herein. It will be appreciated that these embodiments will not deviate from the spirit and scope of the present system and method.

Further, by performing the Authentication Phase 150 over a secure channel protected by the shared secret, the network server 110 and the peer 120 may advantageously avoid the risk of a passive third-party attacker attacking the authentication exchange (e.g. 150).

Finally, it will be appreciated that in the event that the Authentication Phase 150 fails, a compromise solution may be available to the parties 110, 120. A number of compromise implementations may be available that would be dependent on the policies established by a particular network. For example, in one scenario, parties 110, 120 may assume not only that the shared secret has been compromised, but also that one or both of their authentication credentials may have been compromised. In such a case, where the second party is a wireless client and the first party is a network server, the network server may invalidate the credentials of the wireless client and require the wireless client to reestablish the credentials over an out-of-band channel.

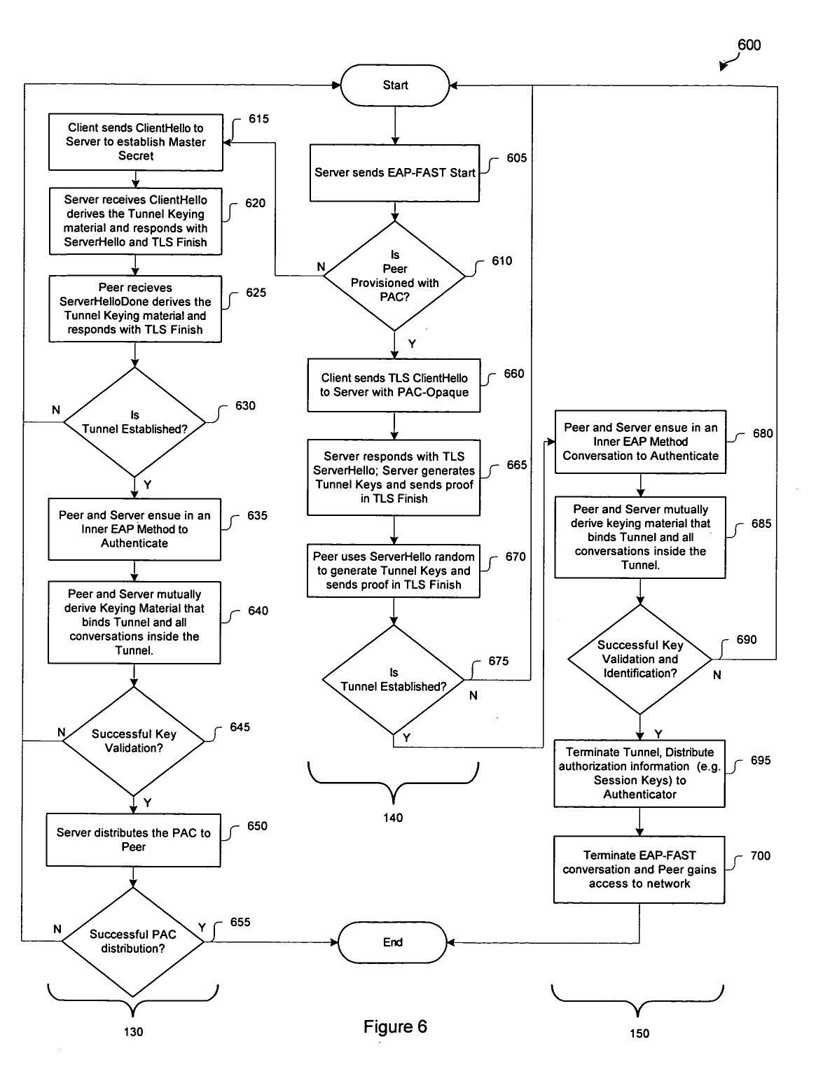

The process flow of the present and system and method may be better understood with reference to FIG. 6. Illustrated in FIG. 6 is an embodiment of a methodology 600 associated with the present system and method. Generally, FIG. 6 illustrates the process used to provision, establish a tunnel and to protected authenticated communications in accordance with the present system and method.

The illustrated elements denote “processing blocks” and represent computer software instructions or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram, as well as the other illustrated diagrams, does not depict syntax of any particular programming language. Rather, the diagram illustrates functional information one skilled in the art could use to fabricate circuits, generate computer software, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. They may also be implemented using various programming approaches such as machine language, procedural, object oriented and/or artificial intelligence techniques. The foregoing applies to all methodologies described herein.

Referring now to FIG. 6, there is illustrated a flow chart of an embodiment of the methodology 600 for protecting communication between network components. Although, the embodiment presumes wireless components of a network system (e.g. wireless client, AP, switch, AS), it will be appreciated that the present innovation may be applied to any network (e.g. wired or wireless) known in the art.

Initially, at block 605, the system initiates the request from the server to commence an EAP-FAST conversation with the peer. Upon receipt of this request, the peer determines whether it has a PAC provisioned for this server (decision block 610).

If at decision block 610, the system determines that provisioning has not yet occurred, the system commences the Provisioning Phase 130 by the peer responding to continuing the EAP-FAST conversation as the initiation of the Provisioning Phase 130; this is achieved by the peer sending a message (e.g. ClientHello) to commence establishment of a PAC (block 615).

At block 620, the server receives the message and employs the random challenge provided by the peer in the ClientHello along with its generated random challenge as a means of ensuing in the Diffie-Hellman key agreement to derive the keying material used to protect the tunnel. Additionally at block 620, the server responds with a message (e.g. ServerHello) to provide the peer with the server's random challenge as well as proof of the tunnel key derivation in the TLS Finish record.

Next, the peer employs the server's random challenge to complete a key agreement (e.g. Diffie-Hellman) to derive the keying material, validate the server's proof included in the TLS Finish and generate the peer's own proof included in the peer's TLS Finish response (block 625).

Next, the system determines if a tunnel has been properly established (decision block 630). If, at decision block 630, the tunnel has not been properly constructed, the peer and server fail the EAP-FAST conversation and the system resets as illustrated in FIG. 6.

On the other hand, if the tunnel succeeds, the peer and server can then initiate another conversation that is protected by the TLS tunnel using the mutually derived keys (block 635). It will be appreciated that the conversation of block 635 may be protected by the tunnel encryption and message integrity protections.

At block 640, the peer and the server use the keying material derived at the tunnel as well as that derived by the inner authentication method to cryptographically bind the tunnel. Additionally, at block 640, both parties validate their respective identity to each other. The validation is accomplished by inclusion of a message authentication code using the compound MAC value to ensure the tunnel's integrity through the use of a cryptographic binding TLV request and response between peer and server.

Next, at decision block 645, the system determines if the key validation is successful. If at decision block 645, the compound MAC fails, the EAP-FAST provisioning conversation fails and the process resets as illustrated in FIG. 6.

If the key validation is successful at decision block 645, the server will provision, that is, distribute the PAC to the peer when the cryptographic binding succeeds (block 650). At block 655, the server validates that the distribution has succeeded by enabling the peer to acknowledge receipt of the PAC. Once the distribution succeeds, the tunnel is torn down and the EAP-FAST provisioning conversation terminates. If the PAC is not successfully distributed, the system is reset as illustrated in FIG. 6.

Returning to block 605, once EAP-FAST is commenced by the server's request. The client determines whether a PAC has been provisioned (decision block 610). In the event that the peer is provisioned with a valid PAC, the client sends a random challenge in the ClientHello as well as the PAC-Opaque established in the provisioning phase (block 660).

Upon receipt, at block 665, the server uses the peer's random challenge, a server generated random challenge and the PAC-Key extracted from the PAC-Opaque to generate the tunnel keying material and responds with a TLS ServerHello and TLS Finish record that includes the proof that it has generated the appropriate keying material.

Next, at block 670, the peer consumes the server's random challenge in the same manner to generate the tunnel keying material and generates its proof of such keying material by responding with a TLS Finish. At this stage, the tunnel key is established between the client and server and the tunnel establishment must be valid through the validation of the TLS Finish records (decision block 675).

If at decision block 675 the secure tunnel is not established (e.g. if either the server or the peer's TLS Finish record is invalid), the EAP-FAST conversation is terminated as a failed authentication and the peer and server may choose to try again. As illustrated, the system returns to the Start block to try again as illustrated in FIG. 6.

Following a successful establishment of the protected tunnel, the system continues to the authentication phase 150 conversation at block 680. Within the protected tunnel, the peer and server ensue in at least zero to many conversations to achieve the required authentication and authorization as defined by the server (block 680). It will be appreciated that the conversations in accordance with block 680 may be protected by the tunnel encryption and method integrity protections. At block 685, both peer and server cryptographically bind all of the accrued keying material to prove tunnel integrity as well as deriving the master session keys.

Next, the system determines if the key validation and identification were successful (decision block 690). At decision block 690, both peer and server must exchange a Result TLV and the Cryptographic binding TLV in order to establish the tunnel integrity and signal a successful authentication result. Further, the server must verify that at least one disclosed identity in the protected tunnel matches the identity disclosed in the PAC-Opaque.

If the validation or verification fails at decision block 690, the EAP-FAST conversation is terminated as a failed authentication and the peer and server may choose to try again as illustrated in FIG. 6.

On the other hand, following a successful validation and verification, the server may distribute the authorization policies to the authenticator (block 695). Additionally, both peer and server terminate the tunnel as per block 695. At block 700, the EAP-FAST conversation is terminated and the peer has gained access to the network with the established authorization policies.

While not shown in FIG. 6, it will be appreciated that following a successful validation and verification, the server may also distribute updated credentials such as a new PAC and or username and password as part of the authorization policies.

It will be appreciated that the methodology 600 illustrated in FIG. 6 describes the provisioning and authentication of a wireless client for a single communication session. One skilled in the art will recognize that subsequent communication sessions may include appropriate portions of the methodology 600 in order to secure communication.

While the present system has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the system, in its broader aspects, is not limited to the specific details, the representative apparatus, and illustrative examples shown and described. Accordingly, departures may be made from such details without departing from the spirit or scope of the applicant's general inventive concept.

Although the preferred embodiment has been described in detail, it should be understood that various changes, substitutions and alterations can be made therein without departing from the spirit and scope of the invention as defined by the appended claims.

1. A method of authenticating communication between a first and a second party, the method comprising:
provisioning a first secure credential between the first party and the second party;
establishing a secure tunnel between the first party and the second party using the first secure credential;
authenticating a relationship between the first party and the second party within the secure tunnel using a second secure credential to establish an authorization policy; and
distributing an update to one of the first secure credential and the second secure credential within the secure tunnel to update the authorization policy.

2. The method set forth in claim 1 further comprising the step of protecting the termination of the authenticated conversation by use of a tunnel encryption and authentication to protect against a denial of service by an unauthorized user.

3. The method set forth in claim 1 wherein the step of provisioning occurs within a wired implementation.

4. The method set forth in claim 1 wherein the step of provisioning occurs within a wireless implementation.

5. The method set forth in claim 1 wherein the first secure credential is a protected access credential (PAC).

6. The method set forth in claim 5 wherein the protected access credential includes a protected access credential key.

7. The method set forth in claim 6 wherein the protected access credential key is a strong entropy key.

8. The method set forth in claim 7 wherein the entropy key is a 32-octet key.

9. The method set forth in claim 6 wherein the protected access credential includes a protected access credential opaque element.

10. The method set forth in claim 6 wherein the protected access credential includes a protected access credential information element.

11. The method set forth in claim 1 wherein the step of provisioning occurs through out-of-band mechanisms.

12. The method set forth in claim 1 wherein the step of provisioning occurs through in-band mechanisms.

13. The method set forth in claim 1 wherein the step of establishing the secure tunnel includes the step of establishing a tunnel key using a symmetric cryptographic technique.

14. The method set forth in claim 13 wherein the step of establishing a tunnel key further includes the step of establishing a session_key_seed to be used in protecting the secure tunnel integrity and establishing a master session key.

15. The method set forth in claim 1 wherein the step of authenticating is performed using EAP-GTC.

16. The method set forth in claim 1 wherein the step of authenticating is performed using Microsoft MS-CHAP v2.

17. A system for communicating via a network, the system comprising:
means for providing a communication link between a first party and a second party;
means for provisioning a first secure credential between the first and the second party;
means for establishing a secure tunnel utilizing the first secure credential;
means for authenticating a relationship between the first party and the second party within the secure tunnel using a second secure credential to establish an authorization policy; and
means for delivering an update to one of the first secure credential and the second secure credential to update the authorization policy.

18. The system for communicating set forth in claim 17 wherein the communication link is a wireless network.

19. The system for communicating set forth in claim 17 wherein the communication link is a wired network.

20. The system for communicating set forth in claim 17 wherein the first secure credential is a protected access credential (PAC).

21. The system for communicating set forth in claim 18 wherein the wireless network is an 802.11 wireless network.

22. An article of manufacture embodied in a computer-readable medium for use in a processing system for communicating via a network, the article comprising:
a provisioning logic for causing the processing system to establish a shared secret between a first and a second party;
a tunnel establishment logic for causing the processing system to establish a secure tunnel based upon the shared secret;
an authentication logic for causing the processing system to authenticate a communication link between the first and the second party within the secure tunnel based upon a secure credential; and
a second provisioning logic for causing the processing system to provision an access; and
a delivery logic for causing the processing system to deliver an update to one of the shared secret and the secure credential via the network.

23. The article set forth in claim 22 wherein the tunnel establishment logic further includes a key generation logic for causing the processing system to generate a secure key for encrypting and signing a communication between the first party and the second party.
